(19) United States
(12) Patent Application Publication
(10) Pub. No.: US 2024/0239996 A1
(43) Pub. Date: Jul. 18, 2024

(54) COMPOSITION AND METHOD FOR FORMING BEADS

(71) Applicant: Aradhita Ajaykumar Parasrampuria, Brooklyn, NY (US)

(72) Inventor: Aradhita Ajaykumar Parasrampuria, Brooklyn, NY (US)

(21) Appl. No.: 18/097,599

(22) Filed: Jan. 17, 2023

(51) Int. Cl. C08L 5/04; C08J 3/215; C08K 5/00; C08K 5/053; C08L 5/06

(52) U.S. Cl. CPC C08L 5/04; C08J 3/215; C08K 5/0041; C08K 5/053; C08L 5/06; B29C 39/10; C08J 2305/04; C08J 2305/06

(57) ABSTRACT

The present invention discloses a composition and method of forming beads. The composition comprises low methoxyl pectin, sodium alginate, glycerin, and nano z coating liquid. The composition further comprises at least one coloring agent. A first mixture comprising the low methoxyl pectin, alginate powder, glycerin, and nano z coating liquid is added in drops to a second mixture comprising calcium chloride and water to form instant sodium alginate-pectin beads.

### BACKGROUND OF THE INNOVATION

### A. Technical Field

The present invention generally relates to embellishments, and, more particularly, to composition and method for forming decorative beads.

### B. Description of Related Art

Embellishments, such as beads are frequently used to decorate items such as jewelry, clothes, homes, etc. The beads are generally made of synthetic materials such as petroleum plastics and synthetic resins. These materials are not readily biodegradable and may deposit as microplastics causing environmental pollution. Further, beads are generally strung or woven, or embroidered by hand to create a simple beadwork project/pattern. Complex beadwork may take weeks of meticulous work with specialized tools and equipment. However, bead weaving is a time-consuming process and requires a high degree of precision to make knots while inserting strings through the beads.

Therefore, there is a need for an alternate raw material to form the beads, and a method to weave the beads. Few existing patent application attempts to address the problems cited in the background as prior art over the presently disclosed subject matter and are explained as follows.

U.S. Ser. No. 11/331,639 assigned to Vera Tchakalova et al. entitled “hydrogel beads” discloses a method for preparing crystalline hydrogel beads. The beads are made of a three-dimensional network of biopolymer chains and an aqueous phase/solution that fills the space between macromolecules. The method involves mixing a continuous phase comprising water and a biopolymer and an internal phase comprising an oil phase and a hydrophobic active ingredient, to form a dispersion.

US20080138416 assigned to Francis Rauh et al. entitled “Method and systems for using biopolymer-based beads and hydrogels” disclose a method and system for using biopolymer-based beads and hydrogel composition. The composition comprising of biopolymers such as alginates and cell attachment peptides. The biopolymer bead includes a bead core of a surface geometry that is spherical, elliptical, and round in shape. The core includes a chitosan film and peptides which are dispersed with alginate polymers. However, the existing prior arts lack to provide an effective composition and method to form and weave biodegradable beads.

Therefore, there is a need for a composition and method to form biodegradable beads. Further, there is a need for a method to weave the beads without intense physical labor.

### SUMMARY OF THE INNOVATION

The present invention discloses a composition and method of forming beads. The composition comprises low methoxyl pectin, sodium alginate, glycerin, and nano z coating. The composition further optionally comprises at least one coloring agent. The coloring agent is selected from the group including natural dye, cellulose nanocrystals, photochromic powder, and green fluorescent protein. In one embodiment, the composition comprises of at least one coloring agent mixed with water totaling to about 200 ml. In another embodiment, the composition comprises low methoxyl pectin of about 3 g, sodium alginate of about 3 g, glycerin of about 5 ml, and nano z coating of about 10 ml.

In one embodiment, the method of forming beads is disclosed. At one step, a first homogenous mixture is formed by mixing low methoxyl pectin, alginate powder, glycerin, and nano z coating liquid. The method of forming the first mixture involves the steps of: using a blender at stir mode for a period of about 10 seconds, and mixing low methoxyl pectin and alginate powder using the blender at stir mode for a period of about 40 seconds; adding and mixing glycerin to a mixture of the pectin and alginate powder at stir mode for a period of about 10 seconds; blending a mixture of glycerin, low methoxyl pectin and alginate powder for a period of about 30 seconds with an interval for a period of about 5 secs for a predefined number of times to form the homogeneous mixture, and adding and mixing nano z coating liquid to the homogeneous mixture at the stir mode for a period of 10 seconds.

At another step, the bubbles from the first mixture are removed by keeping the first mixture at rest for a predefined period. At yet another step, calcium chloride is mixed water to form 3% calcium chloride solution (also referred as a second mixture. At yet another step, the first mixture is added to the second mixture in drops to form instant sodium alginate-pectin beads. The formed beads are in moist condition.

At yet another step, the beads are woven in moist condition. The method of weaving the beads in moist conditions comprises the steps of: folding a string having a first end and a second end at the middle to form two halves of string; stringing at least four beads through the first end of the string, wherein the beads are in moist condition; passing the second end of the string through a fourth bead so that the fourth bead has at least two strings passing through and forms a closed loop of beads; forming a plurality of closed loop of beads, and drying the beads to shrink the beads and create a negative space between the beads, wherein the negative space forms a mesh-like appearance to the plurality of loop of beads.

At yet another step, the beads are woven using a mold. The mold is composed of a first mold section and a second mold section. The first mold section comprises a plurality of spaced-apart first grooves and the second mold section comprises a plurality of spaced-apart second grooves. The position of the second grooves aligns with the position of the first grooves and defines an enclosure when the second mold section is assembled over the first mold section. The mold further comprises at least one long hollow section formed along the length of the mold that connects the plurality of enclosures. The method of weaving beads using the mold comprises the steps of: providing the mold; passing the string through the hollow section to position the string at the enclosure of the mold, filling the enclosure or cavities with the first homogeneous mixture, and filling the enclosure with the second mixture such that the second mixture encloses the first mixture to form and mold a succession of instant sodium alginate-pectin beads on the string. In one embodiment, the enclosure is coated with nano z coating. The nano z coating repels the first homogenous mixture from the surface of the enclosure to form the spherical bead around the string.

At yet another step, at least one sheet made of alginate-pectin material is formed. The method of forming the sheet comprises the steps of: pouring the first homogenous mixture on a flat surface; spraying the second mixture over the first homogenous mixture on the flat surface to solidify the homogenous mixture; removing the excess second mixture from the first homogeneous mixture, by tapping or dabbing the solidified, homogenous mixture with a paper towel to absorb any excess liquid, and drying the first homogenous mixture to form the sheet made of alginate-pectin material.

Other objects, features, and advantages of the present innovation will become apparent from the following detailed description. It should be understood, however, that the detailed description and the specific examples, while indicating specific embodiments of the innovation, are given by way of illustration only, since various changes and modifications within the spirit and scope of the innovation will become apparent to those skilled in the art from this detailed description.

### BRIEF DESCRIPTION OF DRAWINGS

The foregoing summary, as well as the following detailed description of the innovation, is better understood when read in conjunction with the appended drawings. For the purpose of illustrating the innovation, exemplary constructions of the innovation are shown in the drawings. However, the innovation is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a flowchart of a method of forming the beads, according to an embodiment of the present invention.

FIG. 2 exemplarily illustrates a flowchart of a method of weaving the beads of FIG. 1, according to an embodiment of the present invention.

FIG. 3 exemplarily illustrates a mesh of beads formed by the method of FIG. 2.

FIG. 4 exemplarily illustrates a perspective view of a mold, according to an embodiment of the present invention.

FIG. 5 exemplarily illustrates a perspective view of a second mold section of the mold of FIG. 4.

FIG. 6 exemplarily illustrates a method of weaving beads of FIG. 1 using the mold of FIG. 4, according to an embodiment of the present invention.

FIG. 7 exemplarily illustrates a method of forming sheets, according to an embodiment of the present invention.

FIG. 8 exemplarily illustrates a perspective view of a mold, according to another embodiment of the present invention.

FIG. 9 exemplarily illustrates a perspective view the enclosure of the mold of FIG. 8 being filled with the composition to form beads, according to another embodiment of the present invention.

FIG. 10 exemplarily illustrates a perspective view of the mold of FIG. 8 filled with the bead composition, according to an embodiment of the present invention.

FIG. 11 exemplarily illustrates a perspective view of a mesh of beads formed with the mold of FIG. 8, according to an embodiment of the present invention.

### DETAILED DESCRIPTION OF EMBODIMENTS

A description of embodiments of the present innovation will now be given with reference to the Figures. It is expected that the present innovation may be embodied in other specific forms without departing from its spirit or essential characteristics. The described embodiments are to be considered in all respects only as illustrative and not restrictive.

The present invention discloses a composition and method for forming beads. The composition comprises low methoxyl pectin, sodium alginate, glycerin, and nano z coating. The composition further comprises a combination of coloring agent and water. In one embodiment, the composition comprises low methoxyl pectin of about 3 g, sodium alginate of about 3 g, glycerin of about 5 ml, nano z coating of about 10 ml, dye of about 200 ml and a combination of coloring agent and water totaling of about 200 ml.

The composition further comprises at least one coloring agent. In one embodiment, the coloring agent comprises a natural dye. The natural dye, includes but is not limited to, charcoal, cochineal, turmeric, and green and blue spirulina algae. In another embodiment, the coloring agent comprises cellulose nanocrystals. The cellulose nanocrystals are made by upcycling textile waste. For example, the textile waste includes, but is not limited to, cotton-based fabrics, and denim-based fabrics. The beads are coated with cellulose nanocrystal powder to provide a naturally iridescent shine, which creates an interactive experience for the user. In yet another embodiment, the coloring agent comprises of a green fluorescent protein. The green fluorescent protein is extracted from a protein isolated from jellyfish. The green fluorescent protein is encapsulated within the beads to make them appear bioluminescent under the UV light. In yet another embodiment, the coloring agent comprises at least 3% of the photochromic powder. The photochromic powder causes the beads to change color upon interacting with sunlight and to glow in the dark environment. The beads could be used to replace exfoliants/microbeads in cosmetics. Optionally, the composition further includes collagen derived from gelatin, vitamins, and probiotic bacteria to provide benefits to the wearer.

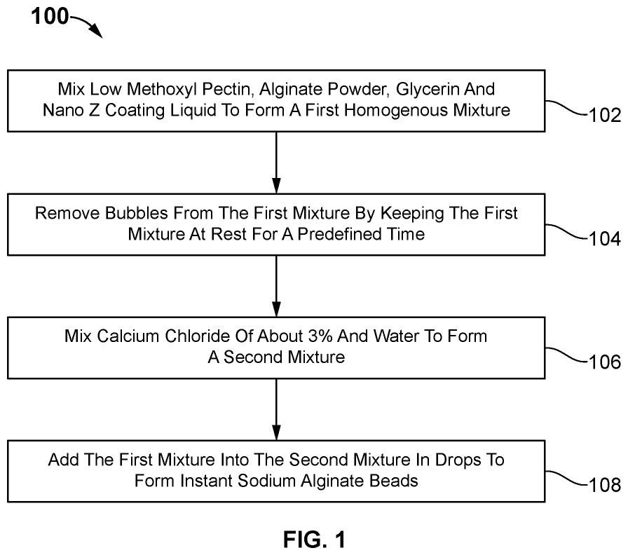

FIG. 1 exemplarily illustrates a flowchart of method 100 of forming the beads, according to an embodiment of the present invention. At step 102, the low methoxyl pectin, alginate powder, glycerin, and nano Z coating liquid are mixed to form a first homogeneous mixture. The first homogenous mixture is also referred to as the first mixture in this document. The first mixture is formed using a blender. The present invention does not require heat to prepare the first mixture. The preparation of the first mixture involves the following steps. The blender is used in stir mode for a period of, for example, about 10 seconds with water. Then, low methoxyl pectin and alginate powder is added and mixed by using the blender at stir mode for a period of about, for example, 40 seconds. Then, glycerin is added to the mixture of low methoxyl pectin and alginate powder using the blender at stir mode for a period of about, for example, 10 seconds. Thereafter, the blender is operated in blend mode. The mixture of glycerin, low methoxyl pectin, and alginate powder are left to blend in the blender for a period of about 30 seconds with an interval for a period of about 5 secs for a predefined number of times to form the homogeneous mixture.

The mixture is blended until the pectin and alginate powder are fully dissolved to form a homogenous solution. In this example, the mixture is blended at least 8 times. Further, the blender is changed to stir mode, and nano Z coating liquid is added and mixed to the mixture of glycerin, low methoxyl pectin, and alginate powder using the blender at stir mode for a period of about, for example, 10 seconds. The nano Z coating liquid makes the first mixture water-resistant. The mixture comprises of bubbles with a cloudy appearance. Thus, at step 104, the first mixture is kept at rest for a predefined period of time, which enables the bubbles to dissolve, and the formation of a clear and translucent first mixture. Further, the water from the mixture also evaporates while the mixture is at rest, for example, within a period of about 9 hours at room temperature. In an example, the mixture could be stored in a container having a number of pores on the lid to facilitate the evaporation of water. The evaporation of water from the first mixture helps to reduce the shrinkage of beads.

At step 106, 3% calcium chloride and water are mixed to form a second mixture. The calcium chloride of about 3 percent and water at room temperature is stirred for a predefined number of times, for example, 87 times. The second mixture is stirred gently for a predefined number of times, for example, 60 times, and the pace is gradually increased for the last 27 stirs.

At step 108, the first mixture is added in drops to the second mixture to form instant sodium alginate-pectin beads. The sodium alginate provides structure to the beads and the low methoxyl pectin provides both structure and shine to the beads. The calcium chloride provides effective results for the spherification process. In another embodiment, calcium acetate, calcium carbonate, and calcium gluconate could be used in the reverse spherification process. The beads are disposed in an enclosed vessel and shaken for a time period of about, for example, 6 hours to form perfect circular beads. For example, the enclosed vessel may be a drum. The perfect circular beads could be used to replace exfoliants/microbeads in cosmetics. The beads could be loaded with vitamins, collegian, or probiotic bacteria to provide health benefits to the user when they rub the alginate-pectin exfoliants against their skin. Optionally, at least one coloring agent is added to the enclosed vessel along with the beads. In one embodiment, the coloring agent is cellulose nanocrystals. The cellulose nanocrystals provide an iridescent color to the beads without the use of any toxic chemicals.

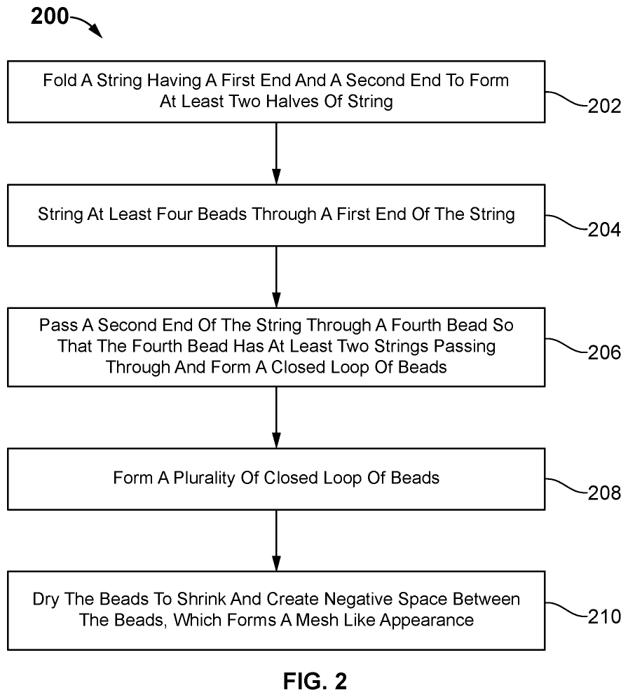

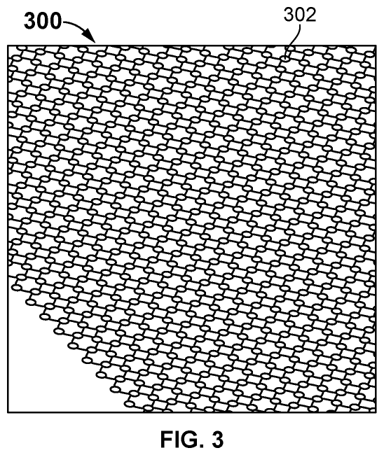

FIG. 2 exemplarily illustrates a flowchart of method 200 of weaving the beads, according to an embodiment of the present invention. The beads formed by method 100 are woven according to method 200 in moist condition. For example, the beads could be woven after a period of about 13 to 15 minutes following the spherification process. At step 202, a string having a first end and second end is provided. The string is folded to form at least two halves. At step 204, at least four beads are strung through at least one end, for example, the first end of the string. At step 206, the second end of the string is passed through the fourth bead to form a closed loop. In another embodiment, at least four beads are strung through at least one end, for example, the second end of the string, and the first end of the string is passed through the fourth bead to form the closed loop. Similarly, at step 208, a plurality of closed loops of beads are formed. At step 210, the formed loops of beads are dried, which shrinks the size of the beads. Each bead shrinks at least 40% in size with respect to the initial size of the bead. The shrinkage of beads creates a negative space between each bead and each loop of beads, which creates and provides a mesh 300 appearance. FIG. 3 exemplarily illustrates a mesh 300 of beads 302 formed by the method 200 of FIG. 2.

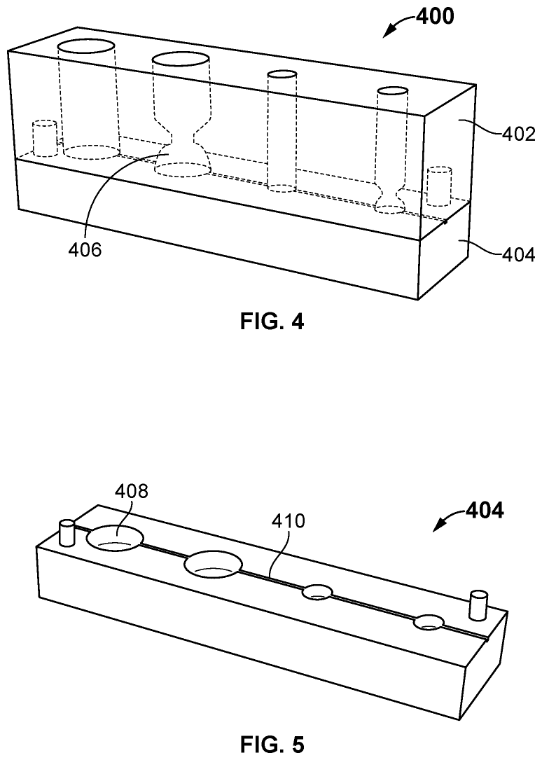

Referring to FIG. 4 and FIG. 5, the mold 400 comprises a first mold section 402 and a second mold section 404. The first mold section 402 comprises a plurality of spaced-apart first grooves 406 and the second mold section 404 comprises a plurality of spaced-apart second grooves 408. The position of the first grooves 406 aligns with the position of the second grooves 408. The first grooves 406 and the second grooves 408 together form an enclosure, or cavity when the second mold section 404 is aligned over the first mold section 402. In one embodiment, the enclosure is circular in shape. In one embodiment, the first grooves 406 and the second grooves 408 have a semi-circular cross-section. Further, the shape of the enclosure could be altered to form varying mesh pattern options. Further, the enclosure could have any shape and any dimension to produce beads of any shape and dimension.

The mold 400 further comprises a hollow section 410 extending along an entire length of the mold 400. The hollow section 410 connects the plurality of enclosures. The hollow section 410 is provided to receive the string therein. The mold 400 further comprises of latches to secure the string at each end of the mold 400 and for creating tension to the string. The hollow section 410 is formed at the second mold section 404. Further, the enclosures are coated with nano z coating and left at rest for at least about 24 hours before using the mold 400.

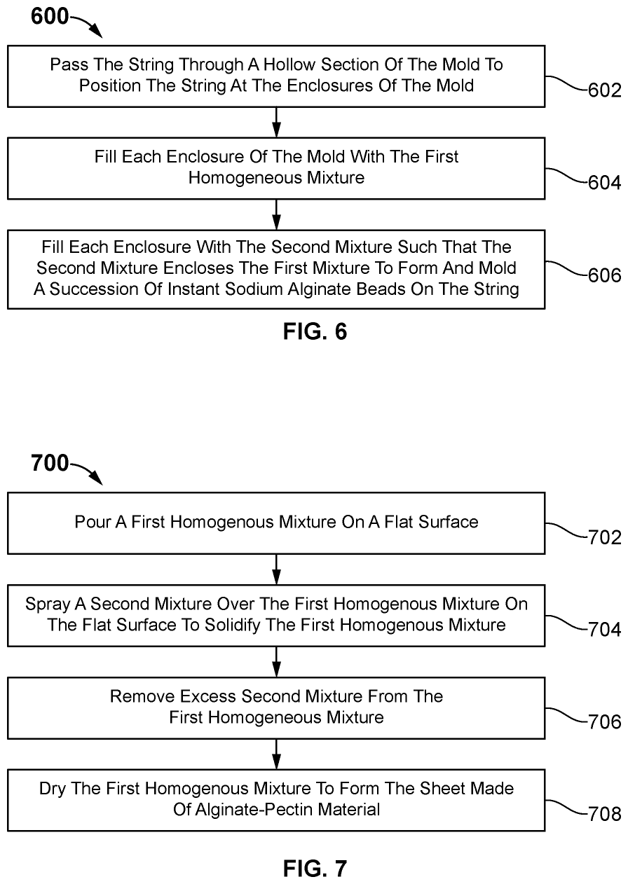

FIG. 6 exemplarily illustrates a method 600 of weaving beads using the mold 400, according to an embodiment of the present invention. At step 602, the string is passed within the hollow section 410 of the mold 400 to position the string at the enclosure of the mold 400. The string is latched to the mold 400. At step 604, the first mixture is dropped to fill each enclosure of the mold 400. The first mixture is filled within the enclosure through the first mold section 402. At step 606, since the mold 400 was coated with hydrophobic nano z coatings, the drops that land on the cavities automatically form a perfect sphere-shaped sodium alginate-pectin beads. Further, the mold 400 facilitates to form a succession of instant sodium alginate-pectin beads on the string. In an example, a pipette could be used to transfer the first mixture to the enclosure. The second mixture solidifies the first mixture to form beads around the string latched onto the mold 400. The Nano z coating on the enclosure repels the first mixture to cause natural formation of spherical beads around the threads. Further, the configuration of the enclosure and the Nano z coated on the enclosure prevents the string from losing tension. In an example, the beads have a circular cross section. In an example, the beads are circular in shape. In another example, the beads are spherical in shape. This method enables the formation of beads automatically around the string, instead of weaving by manual methods. Further, the mold 400 and the bead composition reduce the labor involved in weaving the beads.

Referring to FIG. 7, a method 700 to form sheets using the composition of the present invention is disclosed. At step 702, the first homogenous mixture is poured on a flat surface. The flat surface, includes, but is not limited to, a silicon mat, acrylic surface, and glass surface. For example, if the flat surface is a glass surface, the final flat sheet (at step 708) absorbs shine from the glass surface. At step 704, the second mixture is sprayed over the first mixture such that the second mixture covers the entire surface of the first mixture. The second mixture solidifies the first mixture as the first mixture contacts the second mixture. Thus, forming the flat sheet. At step 706, the excess solution of the second mixture is removed from the surface of the first mixture via a conventional method. For example, a paper towel could be used to absorb excess calcium chloride solution from the first mixture on the flat surface. Thereafter, at step 708, the first mixture is dried at room temperature for a predefined number of days, for example, 4 days. After, the step of drying, the flat sheet could be peeled off from the flat surface.

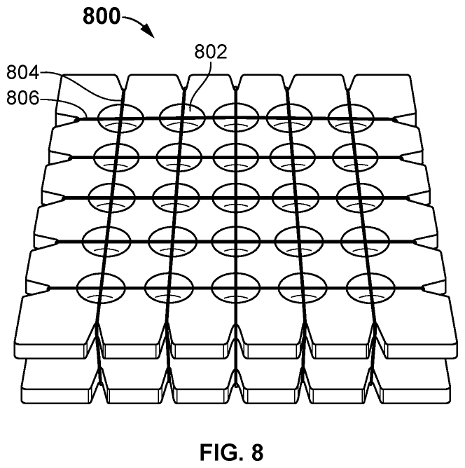

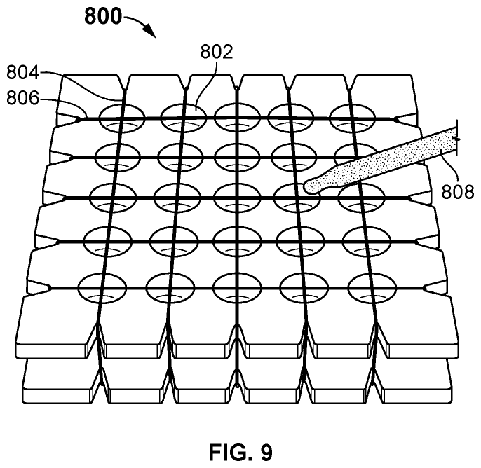

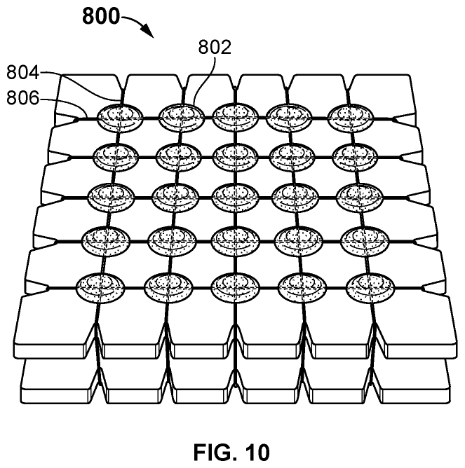

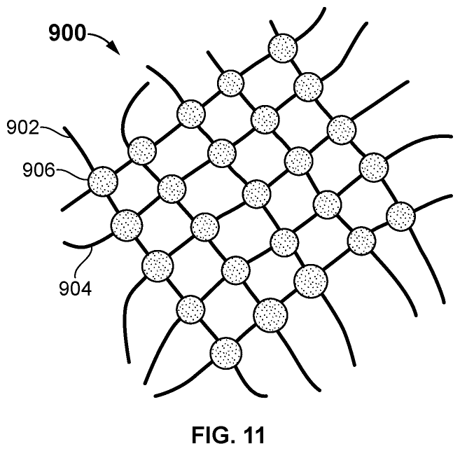

Referring to FIG. 8 to FIG. 10, a mold 800 comprises a plurality of cavities 802. The cavities 802 are formed in an array of rows and columns. A first hollow section 806 extends along an entire length of each row, and a second hollow section 804 extends along an entire length of each column. Further, the mold 800 has water repellent properties. Referring to FIG. 9 to FIG. 11, at least one string 902, 904 is placed on each first hollow section 806 and each second hollow section 804. The strings 902, 904 connect each cavity 802 to one another. Referring to FIG. 9 and FIG. 10, a pipette 808 could be used to fill each cavity 802 with the composition of the present invention. The Nano z coating on the cavity 802 enables natural formation of spherical beads around the strings 902, 904. Referring to FIG. 11, the mold 800 facilitates formation of mesh 900 of beads 906.

Advantageously, the present invention provides biodegradable and renewable beads. The beads could be used to replace exfoliants/microbeads in cosmetics. Furthermore, the beads could be loaded with vitamins, collegian, or probiotic bacteria to provide health benefits to the user when they rub the alginate-pectin exfoliants against their skin. Further, the beads of the present invention are made of natural ingredients, which is healing to produces, consumers, and the environment. Further, the beads of the present invention are lightweight and could be formed in number of colors serving as ideal replacements for exfoliants used in cosmetics. The beads also have bioluminescence characteristics to create interactive experience. Further, the present invention eliminates physical hazards to the workers by making the production, embroidery, and weaving method more time and labor efficient.

Preferred embodiments of this innovation are described herein, including the best mode known to the innovators for carrying out the innovation. It should be understood that the illustrated embodiments are exemplary only and should not be taken as limiting the scope of the innovation.

The foregoing description comprises illustrative embodiments of the present innovation. Having thus described exemplary embodiments of the present innovation, it should be noted by those skilled in the art that the disclosures within this document are exemplary only, and that various other alternatives, adaptations, and modifications may be made within the scope of the present innovation. Merely listing or numbering the steps of a method in a certain order does not constitute any limitation on the order of the steps of that method. Many modifications and other embodiments of the innovation will come to mind to one skilled in the art to which this innovation pertains having the benefit of the teachings in the foregoing descriptions. Although specific terms may be employed herein, they are used only in a generic and descriptive sense and not for purposes of limitation. Accordingly, the present innovation is not limited to the specific embodiments illustrated herein.

What is claimed is:

1. A composition of a bead, comprising: low methoxyl pectin, sodium alginate, glycerin, and nano z coating liquid.

2. The composition of claim 1, further comprises coloring agent and water, the coloring agent and water have a total weight of about 200 ml.

3. The composition of claim 1, further optionally comprises at least one coloring agent, wherein the coloring agent is selected from the group including: natural dye, cellulose nanocrystals, photochromic powder, and green fluorescent protein.

4. The composition of claim 1 comprises low methoxyl pectin of about 3 g, sodium alginate of about 3 g, glycerin of about 5 ml, and nano z coating of about 10 ml.

5. A method of forming and weaving beads, comprising the steps of:
mixing low methoxyl pectin, alginate powder, glycerin and nano z coating liquid to form a first homogenous mixture;
removing bubbles from the first mixture by keeping the first mixture at rest for a predefined period of time;
mixing calcium chloride of about 3% and water to form a second mixture, and adding the first mixture into the second mixture in drops to form instant sodium alginate-pectin beads, wherein the beads are in moist condition.

6. The method of claim 5, wherein the step of forming the first homogenous mixture involves:
using a blender at stir mode for a period of about 10 seconds;
mixing low methoxyl pectin and alginate powder using the blender at stir mode for a period of about 40 seconds;
adding and mixing glycerin to a mixture of the pectin and alginate powder at stir mode for a period of about 10 seconds;
blending a mixture of glycerin, low methoxyl pectin, and alginate powder for a period of about 30 seconds with an interval for a period of about 5 secs for a predefined number of times to form the homogeneous mixture, and
adding and mixing nano z coating liquid to the homogeneous mixture at the stir mode for a period of 10 seconds.

7. The method of claim 5, further comprises the step of: weaving the beads in moist condition.

8. The method of claim 7, wherein the step of weaving further comprising the steps of:
folding a string having a first end and a second end to form at least two halves of string;
stringing at least four beads through the first end of the string, wherein the beads are in moist condition;
passing a second end of the string through a fourth bead so that the fourth bead has at least two strings passing through and forms a closed loop of beads;
forming a plurality of closed loops of beads, and
drying the beads to shrink the beads and create a negative space between the beads, wherein the negative space forms a mesh-like appearance to the plurality of the loop of beads.

9. The method of claim 5, further comprising a step of: weaving the beads using a mold, comprising the steps of:
providing the mold comprising:
a first mold section comprises a plurality of spaced-apart first grooves, a second mold section comprises a plurality of spaced apart second grooves, the position of the second grooves aligns with the position of the first grooves and defines an enclosure when the second mold section is assembled over the first mold section, and
at least one hollow section formed along a length of the mold connects the plurality of enclosures,
passing the string through the hollow section to position the string at the enclosure of the first mold;
filling the enclosure with the first homogeneous mixture, and
filling the enclosure with the second mixture such that the second mixture encloses the first mixture to form and mold a succession of instant sodium alginate-pectin beads on the string.

10. The method of claim 9, wherein the enclosure is coated with Nano Z coating, the Nano Z coating repels the first homogenous mixture from the surface of the enclosure to form the bead around the string.

11. The method of claim 5, further comprises a step of: forming at least one sheet made of alginate-pectin material comprising the steps of:
pouring the first homogenous mixture on a flat surface;
spaying the second mixture over the first homogenous mixture on the flat surface to solidify the homogenous mixture;
removing the excess second mixture from the first homogeneous mixture, and drying the first homogenous mixture to form the sheet made of alginate-pectin material.
